(19) United States
(12) Patent Application Publication
(10) Pub. No.: US 2020/0050461 A1
(43) Pub. Date: Feb. 13, 2020

(54) METHOD FOR BOOTING A DATA PROCESSING SYSTEM AND AIR DEFENSE SYSTEM

(71) Applicant: DIEHL DEFENCE GMBH & CO. KG, Ueberlingen (DE)

(72) Inventor: ANDREAS KOLTES, UEBERLINGEN (DE)

(21) Appl. No.: 16/532,897

(22) Filed: Aug. 6, 2019

(30) Foreign Application Priority Data
Aug. 7, 2018 (DE) 102018006226.1

(51) Int. Cl. G06F 9/4401; G06F 9/445

(52) U.S. Cl. CPC G06F 9/4401; G06F 9/44578

(57) ABSTRACT

A method boots a data processing system. To achieve particularly fast booting, it is proposed for a boot loader to be transferred from a non-volatile data memory to a CPU. For the boot loader to boot the data processing system and prompt a situation whereby compressed program data from the non-volatile data memory are decompressed by the CPU and are stored in decompressed form in a volatile data memory, are called therefrom at a program startup, and are used to execute a program.

### CROSS-REFERENCE TO RELATED APPLICATION

This application claims the priority, under 35 U.S.C. § 119, of German application DE 10 2018 006 226.1, filed Aug. 7, 2018; the prior application is herewith incorporated by reference in its entirety.

### BACKGROUND OF THE INVENTION

### Field of the Invention

The invention relates to a method for booting a data processing system.

When an electronic data processing system is started up, it is booted after the voltage supply is established. To this end, program data are loaded from a non-volatile data memory into a volatile data memory of the electronic system and are processed by the CPU until the program has been executed to the extent that operational readiness of the electronic system is established. The electronic system is then ready to take on and execute further tasks in accordance with the program. This procedure of establishing operational readiness may take some time.

### SUMMARY OF THE INVENTION

The object of the present invention is to provide a method for the fast booting of a data processing system.

This object is achieved by a method of the type mentioned at the outset, in which compressed program data from a non-volatile data memory are decompressed by the CPU and are stored in decompressed form in a volatile data memory, are called therefrom at a program startup, and are used to execute the program startup.

The invention is based on the observation that it may be the case, when using a defense system, which the defense system has to be ready for use very quickly if a threat from an attacking system has been detected. There is sometimes only enough time to be able to successfully combat the threat if the defense system is quickly ready for use. By way of example, air defense systems require full functional capability to be established in a very short time in order to be able to react to threats that arise, such as flying missiles, with a very short delay time by firing one or more defense missiles.

Modern guided missiles have increasingly complex and powerful electronic computer units that are embedded in the weapon system and have to be made operationally ready in a short time. When starting up such a computer unit, it is necessary to transfer increasingly large amounts of data, with increasing system complexity, from a slow, non-volatile data memory, such as a flash chip, into a fast but volatile working memory, such as a DDR RAM chip. Since the transfer speeds of non-volatile memories do not increase at the same speed as the data volumes to be transferred, a data transfer from the non-volatile memory to the CPU or to the volatile memory may form a temporal bottleneck during booting and/or subsequent further startup steps of the computer unit. To increase the boot speed and thus to achieve establishment of readiness of use of the computer unit more quickly, improved startup concepts are necessary in order to be able to achieve or even surpass the fast startup times of earlier systems, even with high system complexity.

This problem is solved by the invention in that the program data are stored in compressed form in the non-volatile memory and thereby form a smaller amount of data that has to be transferred to the volatile memory. The decompression of the program data, as an additional step in this case, requires less additional time than the transfer of compressed data in comparison with a transfer of uncompressed data saves. A startup of the data processing system, which may be the booting or involve yet further steps, is able to be sped up, and the electronic system is ready for use more quickly.

Program data used to boot the data processing system, in this respect, are in compressed form in the non-volatile memory, which also contains these data in the unpowered state. When the voltage supply of the CPU and of the memory is established, these data may be transferred to the CPU and decompressed by the CPU, possibly in combination with the volatile memory, and be transferred into the volatile memory in the decompressed state. The program is then present therein in unzipped form, that is to say in decompressed form, and may be executed in order to boot the data processing system. That is to say, the data required for booting are initially decompressed and may then be used to execute further steps of the startup of the data processing system.

The booting of the data processing system may involve or be loading an operating system of the data processing system. The operating system may contain one or more programs that manage the system resources of the data processing system. Such a resource may be a field-programmable gate array (FPGA), whose configuration data may be program data of the boot procedure. The data processing system may be a hybrid system having a CPU and an FPGA in which data for logic circuits are loaded, by way of which the FPGA is configured. In this respect, the booting may involve loading and executing firmware for establishing the operational capability of the FPGA, and also further program software for establishing the operational capability of further components. The loading may involve the decompression.

To boot the data processing system, a boot loader may be transferred from the non-volatile data memory to the CPU and/or the volatile memory, which boot loader initiates the booting of the data processing system. The boot loader is expediently stored in the non-volatile memory in uncompressed form. The boot loader may initiate the decompression of the program data.

The booting of the data processing system may involve having to execute a program in order to establish the regular operational readiness of the data processing system, without which program the data processing system is not ready for use. The readiness for use may be the regular readiness for use that the data processing system has to exhibit in order to execute its basic tasks. A program startup may be the startup of the execution of executable software, firmware and/or configuration software for configuring an FPGA.

In this respect, in one embodiment of the invention, it is expedient for the program data to be FPGA firmware by way of which an FPGA is configured. The boot loader may initiate the configuration of the FPGA with the data from the volatile memory.

The CPU and the FPGA advantageously form an embedded system of the data processing system, in which both units are in particular arranged on a common circuit board. The embedded system is expediently incorporated into a technical context, for example into a missile system for launching one or more missiles.

In a further advantageous configuration of the invention, the compressed program data are compressed on a machine word level, and the compression method thus uses coding on a machine word level. It is accordingly advantageous for the decompression to take place on a machine word level.

The compressed data may be present as a single continuous data block and be decompressed so as to form a single continuous data block. The program data are expediently present exclusively in the form of words of multi-byte size of the same size, that is to say integer bytes, in particular exclusively in the form of 4-byte words, both in compressed form in the non-volatile data memory and in decompressed form in the volatile data memory. That is to say, the decompressor receives a data block consisting just of 32-bit integer values and outputs a decompressed data block consisting just of 32-bit integer values.

Particularly efficient compression is able to be achieved if the program data are compressed by way of a first compression method, expediently from the LZ family (Lempel-Ziv compression), and are decompressed using the corresponding methods, for example by way of LZ77. Using a compression method from the LZ family, each word of the uncompressed data is able to be converted into a token, so that the compressed data describe the uncompressed data through a sequence of tokens. Subsequent Huffman compression is furthermore advantageous. The decompression expediently takes place using the same methods in reverse order.

A token may reproduce a word from the uncompressed data true to character or reference an already decompressed word in a predefined way, which word is completely or partly identical to the word that is coded by the token. In the decompression, the decompressor is able to extract, from the offset specified in the token, that is to say from the distance from the referenced word to the word that it represents itself, specified in word lengths, data of its word from the same data of the referenced word that has already been decompressed.

The Huffman compression may use what is known as a Huffman tree in which each token is assigned one or more characters, wherein the length of such a character string in the case of tokens that are used often is shorter than in the case of tokens that are used less often.

A further advantageous configuration of the invention makes provision for the program data to be entropy coded in the non-volatile memory and for all of the data used to start up the data processing system to be decompressed by way of at most three Huffman trees. These Huffman trees are expediently used to decompress the entire program code that is required to boot or start up the data processing system. In addition to loss-free compression, efficient decompression is thereby able to take place.

The Huffman trees may be arranged in the compressed data block between the header and the compressed data portion. Expediently, the maximum length of the Huffman symbols is limited to 12 bits in the main tree and to 10 bits in the two offset trees.

Each Huffman tree may be assigned an alphabet. A main alphabet may describe the type of the respective token. A first offset alphabet may describe the offset of single-word repetitions and a second offset alphabet may describe the offset of multi-word repetitions.

Advantageously, one of the Huffman trees is used to determine a type of token and at least one further Huffman tree is used to determine the backwards offset to data of the same type, such as single-word or multi-word repetitions. Tokens may be described in the compressed data by way of one or two symbols of a respective Huffman tree, possibly followed by a predetermined number of further bits containing further information.

Lookup tables are used to decode or decompress the data through Huffman trees. These lookup tables are expediently designed such that they fit completely into the L1 cache of the CPU of the data processing system that executes the decompression algorithm. To achieve this, it is expedient for the decompression to use at most three single-stage lookup tables that each consist of a field of at most 4096 16-bit values. In this case, the lookup tables are expediently adapted to the Huffman trees. Two of the lookup tables may consist of 1024 16-bit values.

Particularly fast decompression is able to be achieved if the compressed program data form a complete program dataset. This is expediently routed exclusively through the L1 cache of the CPU for the decompression. Access operations to already decompressed data may take place at least predominantly on the L2 cache of the CPU in order to further decompress the program data. In this way, there does not have to be any RAM access in order to read already decompressed data. The access operation lengths are expediently selected, in particular so as to be so short, that the data that are accessed fit at least predominantly into the L2 cache.

As described, tokens may be used for the decompression, which tokens contain, as data content, a symbol for the type of token at the front and optionally a symbol for an offset and/or an extra bit behind this, these expediently being limited to a maximum of 32 bits. The number of extra bits may be defined by the type of token.

One or more of any one of the following categories are expedient as a type of token:
True to character reproduction, also called Verbatim or Literal,
Single-word repetitions, also called Short,
Multi-word repetitions, also called Long, and
Strings of identical words, also called Run.

Each token category may contain a plurality of token types. The category of tokens of true to character reproduction may contain one or more of any one of the following token types:
Zero word consisting only of zeros,
A true to character reproduction of a word,
Front zeros portion,
Rear zeros portion,
Front ones portion, and
Rear ones portion.

In other words, a literal token category containing tokens may be used for the decompression, which category compresses a series of characters consisting of zeros or ones placed at the front or placed at the rear separately from the literal portion, that is to say the true to character portion.

The category of single-word repetitions may contain one or more of any one of the following token types:
Identical word,
Identical word with 1 bit difference,
Identical word with 2 bit difference, and
Jump command.

In other words, a token category may be used for the decompression whose tokens each refer to an earlier, that is to say already decompressed word, and permit changes of one or two bits—which are then expediently situated behind one another.

The category of multi-word repetitions may contain one or both of the following token types:
Number of identical words coded by type of token, and
Number of identical words coded by extra bit.

In other words, a token category may be used for the decompression whose tokens each reference a plurality of identical words situated immediately behind one another.

The category of strings of identical words may contain one or both of the following token types:
Number of repetitions coded by type of token, and
Number of repetitions coded by extra bit.

In other words, a token category may be used for the decompression whose tokens each refer to a series of identical words situated immediately in front of one another.

In particular in the case of a decompression of program data for FPGA configuration, it is effective, for the decompression of different token types, if the order of the token types is checked such that token types of the true to character token category are checked first of all, and then token types of the token category of single-word repetitions are checked and then further token types of the true to character token category are checked.

As described, it is expedient for the program data to form a complete program dataset that is compressed as a single data block. Its model portion may contain all of the decoding trees that are used for the decompression. The program data expediently form one or more continuous complete programs that is/are thus executable.

It is furthermore advantageous for the compressed data to be present in two interlinked sequences each consisting of words of the same length. In this case, the first word sequence may consist of compressed data and the second word sequence may consist of uncompressed data. All of the words in both sequences expediently have the same length.

If a plurality of computer cores is present in the CPU, it is possible to achieve fast decompression if the compressed program data are present in a plurality of data blocks, the number of data blocks matching the number of computer cores of the CPU. The data blocks may be fed in parallel to the computer cores for decompression, such that the parallel processing speeds up the decompression. The data blocks each expediently form a continuous decompressed program data portion. To achieve even loading of the individual computer cores, it is advantageous for the numbers of tokens in the data blocks to differ from one another by at most 20%.

The invention also targets an air defense system having a missile and a data processing system for controlling operation of the missile, wherein the data processing system has a CPU, a volatile memory and a non-volatile memory and contains software which, when it is executed, has the effect that compressed program data from the non-volatile data memory are decompressed by the CPU and are stored in decompressed form in a volatile data memory, are called therefrom at a program startup and are used to execute the program.

The missile may contain the data processing system that controls its flight, and/or a launcher from which the missile is launched may contain the data processing system, this data processing system then controlling the launch.

The invention is also advantageous in general for a data processing system as such that has a CPU, a volatile memory and a non-volatile memory and contains the described software. The data processing system is expediently what is known as an embedded system having a CPU and an FPGA, expediently on a common circuit board. The volatile memory may be configured such that it at least predominantly loses its data when powered off, whereas the non-volatile memory retains its data when powered off.

The description given up until now of advantageous configurations of the invention contains numerous features that are partly reproduced in combination of several thereof in some dependent claims. The features may however also expediently be considered individually and combined so as to form expedient further combinations, in particular in the case of back-references of claims, such that an individual feature of a dependent claim is able to be combined with one, a plurality or all of the features of another dependent claim. These features are furthermore each able to be combined individually and in any suitable combination both with the method according to the invention and with the data processing system according to the invention, in particular in accordance with the independent claims. Method features should thus also be regarded, worded in terms of subject matter, as properties of the corresponding device unit, and functional device features should also be considered to be corresponding method features.

The above-described properties, features and advantages of this invention and the manner in which these are achieved become clearer and more clearly comprehensible in connection with the following description of the exemplary embodiments, which are explained in more detail in connection with the drawings. The exemplary embodiments serve to explain the invention and do not limit the invention to the combination of features specified therein, including not in relation to functional features. Features of a respective exemplary embodiment that are suitable for this purpose may furthermore also explicitly be considered in isolation, removed from one exemplary embodiment, incorporated into another exemplary embodiment in order to supplement it and/or combined with any one of the claims.

Other features which are considered as characteristic for the invention are set forth in the appended claims.

Although the invention is illustrated and described herein as embodied in a method for booting a data processing system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing an air defense system having a plurality of missiles, each of which is mounted in a canister, and a data processing system;

FIG. 2 is a flowchart for booting a data processing system according to the invention;

FIG. 3 is an illustration showing an overview of a compression and decompression procedure for program data; and

FIG. 4 is a flowchart showing the decompression of main symbols of tokens.

### DETAILED DESCRIPTION OF THE INVENTION

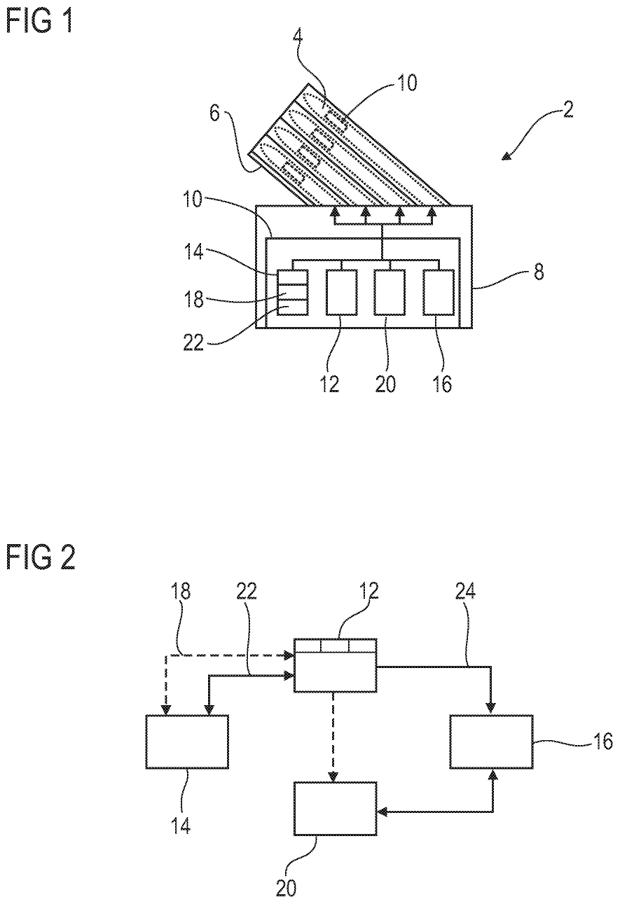

Referring now to the figures of the drawings in detail and first, particularly to FIG. 1 thereof, there is shown an air defense system 2 having a plurality of missiles 4, each of which is mounted in a canister 6. The canisters 6 are installed on a vehicle 8, for example a lorry or a ship, and are able to be pivoted out of a horizontal mounting position into an inclined or vertical firing position, as illustrated in FIG. 1.

The air defense system 2 furthermore contains a data processing system 10 having a processor or a CPU 12 that has a data connection to a non-volatile memory 14 and a volatile memory 16. The non-volatile memory 14 contains software 18 for starting up the data processing system 10 and thus for establishing operational readiness of the data processing system 10 or air defense system 2. The data processing system 10 has a signal connection to each individual one of the plurality of missiles 4, as indicated by the arrows in FIG. 1. Firing of the missiles 4 is able to be controlled using the data processing system 10.

In addition to the CPU 12, an FPGA 20 is present, whose data output brings about a considerable portion of the control of the air defense system 2 or of the individual missiles 4. Software 22 is present in order to configure the FPGA 20, which software is present in the non-volatile memory 14 in compressed form before the data processing system 10 is started up. CPU 12 and FPGA 20 form what is known as an embedded system on a common circuit board.

It is also possible in principle for each of the missiles 4 to have a data processing system 10 as described above. The air defense system 2 may then either have a simpler design, since complex control procedures take place in the missile 4 itself, or both the missile 4 and the air defense system 2 each contain a data processing system 10 as described above. In this case, the control procedures when a missile 4 is launched may be distributed between the two data processing systems 10 in the missile 4 and in the air defense system 2. It is also possible for the data processing system 10 of the air defense system 2 to control the launch, and for the data processing system 10 to control the further flight of the missile. The procedures executed in the data processing system 10 for all these cases are described below.

If the intention is to launch a missile 4, it may be the case that the launch procedure needs to be executed very quickly since there is only a short time to defend against a threat. The data processing system 10 has to be booted before it is able to output the control commands required for the launch. After booting, the data processing system 10 controls the launch of the missile 4. A flight of the missile 4 may be controlled by a data processing system 10 in the missile.

A schematic illustration of the booting of the data processing system 10 is shown in FIG. 2. For the booting, the data processing system 10 and thus the CPU 12 and the two memories 14, 16 are each supplied with their operating voltage. The CPU 12 then calls the software 18, for example a boot loader, from the non-volatile memory 14, as illustrated by the dashed double-headed arrow between CPU 12 and memory 14. The CPU 12 may have its cache memory already integrated, as indicated by the three fields in the upper region of the CPU for L1 cache, L2 cache and L3 cache. The cache also forms a volatile memory.

The boot loader has the effect that the software 22, which is present in the non-volatile memory 14 in the form of compressed program data, is loaded into the CPU 12 and is decompressed there in collaboration with the volatile memory 16. The CPU 12 thus calls the program data 22 from the non-volatile memory 14, as illustrated by the double-headed arrow between CPU 12 and memory 14.

The decompressed program data 24 are FPGA firmware in this exemplary embodiment. They are stored in the volatile memory 16, and it is awaited until the program data 22 are decompressed and stored, either in their entirety or in individually operating program portions. The FPGA 20 is then informed of an address and given the load command by the CPU 12. This is illustrated by the dashed arrow from CPU 12 to the FPGA 20. The FPGA 20 retrieves the decompressed program data 24 from the volatile memory 16 and configures itself therewith, as illustrated by the double-headed arrow between FPGA 20 and memory 16.

After this booting of the data processing system 10 has completed, said data processing system takes over control of the missiles 4 or the launch thereof. For this purpose, further decompressed program data 24 may then be called at a program startup and used to bring about the program startup or performance of the control.

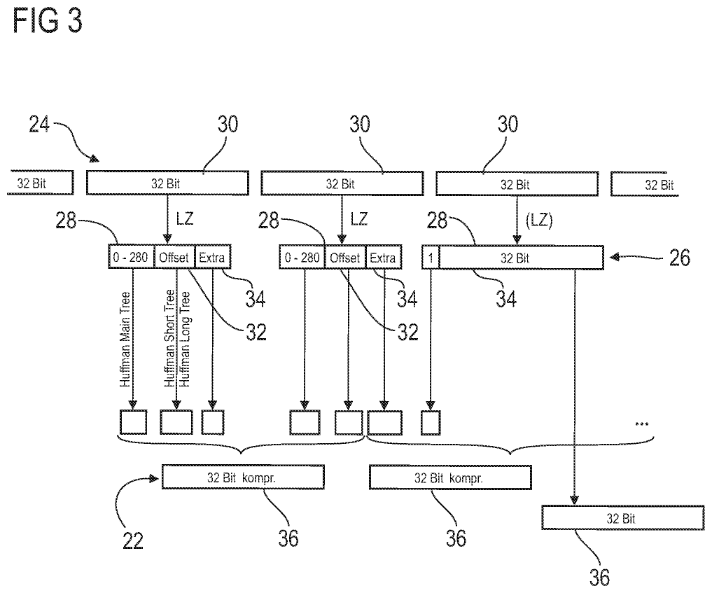

To establish the executability of the program data 22, these first of all have to be decompressed. FIG. 3 shows the compression and decompression method for these program data 22. The compressed program data 22, as present in words 36 and stored in the non-volatile memory 14, are illustrated schematically. The compressed program data 22 are present in the form of a single block of compressed data as such. This data block is however divided into a multiplicity of units in each case of a size of 4 bytes or words 36, as illustrated schematically in the lower part of FIG. 3 by the separation into words 36 each of a size of 32 bits. The smallest data unit in the compressed data 22 is in this respect the word of a size of 32 bits, which takes up 4 bytes of memory space. The same also applies to the decompressed program data 24, which are likewise present in the form of a single data block, which is however also divided into units of a size of 4 bytes or words 30. This data division allows efficient data processing that avoids a slower byte size data granularity.

To simplify understanding of the method for decompressing the compressed program data 22 into the decompressed program data 24, the data compression is first of all described.

The uncompressed program data 24 are first of all compressed using a compression method from the LZ family, for example LZ77, to an intermediate stage 26. In a second step, the thus pre-compressed program data are compressed using a Huffman compression, as illustrated schematically in FIG. 3. In the corresponding decompression, the compressed program data 22 are first of all decompressed by way of Huffman methods or Huffman trees to the intermediate stage 26, in which the data are present in token form, that is to say as a series of tokens 28. Before this intermediate level 26, the data are converted into the decompressed program data 24 by way of LZ decompression.

The compressed data block that contains all of the program data 22 for starting up a program, for example for configuring the FPGA 20, consists of 3 portions: a header that describes at least one property of both the compressed and the uncompressed data block, and then a model portion that contains three Huffman trees, and as third portion the actual compressed data from which the decompressed program data 24 are reproduced. Both data blocks 22, 24 each consist of a multiplicity of 32-bit words 36, 30.

The intermediate level 26 that is present after the first compression method consists of a sequence of tokens 28 that each comprise a first portion that indicates the type of token. In the exemplary embodiment that is shown, there are 281 types of token, which are numbered consecutively from 0 to 280. This first portion may be adjoined by at most two further portions, whose length and content is dependent on the type of token. A further portion of the token 28 may in this respect indicate an offset 32 or an entire uncompressed 32-bit-long word. Depending on the type of token, a third portion containing extra bits 34 is also possible. The types of token are grouped into 4 categories: True to character reflection, single-word repetition, multi-word repetitions or strings of identical words.

In the second compression step, these tokens 28 are compressed further using a plurality of Huffman trees. A first Huffman tree indicates the type of token and therefore comprises all of the types of token in its tree structure. In addition to this main tree, there are one or more Huffman trees, in this exemplary embodiment two trees, by way of which the offset portion 32 is compressed further. The extra bits 34 are not compressed further in the second compression method. A separate Huffman tree is used for the second compression for the single-word repetitions and for the multi-word repetitions, respectively.

The decompression may take place in streaming. The decompressor, for example the CPU 12, is able to read the compressed program data 22 in a single run from the startup to the end without having to access the volatile memory 16. The decompressed program data 24 may likewise be output in a type of streaming, access to the volatile memory 16 then however being necessary in order to copy previously decompressed words 30. In most cases, however, the words 30 to be copied are so close that they are still in the L2 cache, such that very quick access is possible.

All of the uncompressed program data 24 are reproduced by a sequence of tokens 28 in the intermediate level 26 of the compression. Each token 28 belongs to one of the four token categories. A token from the category of true to character reproduction consists of an entire uncompressed word 30 or of a portion thereof, if the rest of the word 30 consists exclusively of zeros or ones in front of or behind the word portion reproduced true to character.

A token 28 from the category of single-word repetitions reproduces a word that has already been decompressed previously in the decompression method, that is to say a word repetition in the uncompressed program data 24. This token category also contains tokens 28 that form a word repetition with a difference of one or two bits from the already decompressed almost identical word 30.

In the multi-word repetition type of token, there are only tokens 28 that in each case exactly repeat a plurality of words situated behind one another that have already previously been decompressed. Tokens 28 from the multi-word repetitions thus refer to a series of two or more already decompressed words 30 that are repeated exactly in this way in the uncompressed program data 24.

The token types from the category of strings of identical words stand for one or more repetitions of a single word 30 immediately in front of the word 30 to be decrypted that is represented by the token 28.

A table of all of the used types of token from the category of true to character reproduction is indicated below.

TABLE 1
Tokens from the category of true to character reproduction

| | Main | Number of | |
|---|---|---|---|
| | symbol | extra bits | |
| Token type | (S) | (B) | Word |
| Zero | 0 | 0 | 0 |
| Verbatim | 1 | 32 | B |
| Short | 67-87 | S-67 | 2^{S-67} + B |
| Sparse | 88-108 | S-88 | B × 2^{32-(S-88)} + 2^{32-(S-88)-1} |
| Short Negative | 109-129 | S-109 | −(2^{S-67} + B) |
| Sparse | 130-150 | S-130 | −(B × 2^{32-(S-88)} + 2^{32-(S-88)-1}) − 1 |
| Negative | | | |

The first column indicates the token type. The second column indicates the main symbol S that is used in the second portion of the Huffman compression. Each type of token has a specific main symbol S. In this exemplary embodiment, the main symbols are in the form of a number from 0 to 280. However, this is described only by way of example, and another main symbol may also be present instead of the specific numbers depicted below.

The table thus contains a token category having six token types, which together contain 86 types of token, which thus occupy 86 main symbols. Each type of token—as far as the type of token “zero”—has many possibilities for tokens 28 that result from one or more extra bits. The number of extra bits in the individual token types is depicted in the third column. The fourth column depicts the uncompressed word 30 of the program data 24.

The first token type “zero”, which bears the main symbol 0 in this exemplary embodiment, has just a single type of token that indicates an uncompressed word 30 that consists only of zeros. The corresponding type of token in this respect consists just of a single token 28 having a first portion, which in turn consists just of a zero.

The token type “Verbatim” stands for the true to character reproduction of 32 bits of a word 30. The corresponding tokens 28 consist of a first portion, which consists of just a 1 as main symbol, and a 32-bit true to character reproduction. Such a token 28 is illustrated by way of example in FIG. 3 as a third token 28.

The token type “Short” contains a plurality of types of token, in the exemplary embodiment described here 21 types of token. Each type of token stands for a word having a predefined number of zeros at the front and a verbatim portion situated behind this, that is to say a portion that is indicated true to character by extra bits. The number of zeros at the front results from the main symbol S.

If an uncompressed word 30 consists for example of a rear portion having 7 bits, whose frontmost bit is a 1, and a front portion consisting of 25 bits that are just zeros, then six extra bits are enough to completely describe the word 30. The six extra bits indicate the last six bits of the word 30, the bit before this must be a 1, and the 25 bits in front of this are zeros. Such a word 30 bears the main symbol S=73, wherein the number of extra bits 34 totals S−67=6. In accordance with the last column, the uncompressed word 30 consists of the number 2⁶+B, wherein B indicates the last six characters.

The fourth token type “Sparse” in each case describes a word 30 whose rear portion consists of a series of zeros. The portion at the front—as far as the first 1 seen from the rear—is repeated as a true to character reproduction using extra bits. As in the case of “Short”, there is also the same number of types of token, in this exemplary embodiment 21 types of token, in the case of “Sparse”. Each type of token stands for the number of zeros at the front (“Short”) or at the rear (“Sparse”) of the word 30. In this respect, the main symbol S unambiguously predefines the number of zeros at the front or at the rear.

The two token types “Shorts negative” and “Sparse negative” are the same as “Short” and “Sparse”, the numbers at the front or at the rear however not being zeros, but rather ones.

Generally speaking, the token category of the true to character reproduction contains any desired number or all of the six token types, of which two contain only one type of token and four token types each contain a multiplicity of various types of token, the number of types of token that are contained being able to be the same, in each case 21 as in this exemplary embodiment. The types of token contain a number of 0 to 32 extra bits that reproduce the length of the word portion that is repeated true to character. This word portion may comprise the entire word 30 (Verbatim) or not be present (Zero) or comprise just a word portion smaller than 32 bits, the rest of the word consisting of zeros or ones in front of or behind this word portion.

A table containing types of token from the category of single-word repetitions is depicted below.

TABLE 2
Tokens from the category of single-word repetitions

| | Main | |
|---|---|---|
| | symbol | Decompressed |
| Token type | (S) | (X = Source Word, O = Offset) |
| Verbatim | 2 | X |
| 1-Bit Delta | 3-34 | X ⊕ 2^{S-3} |
| 2-Bit Delta | 35-65 | X ⊕ (3 × 2^{S-35}) |
| ARM Branch | 66 | 0xEB000000 + ((X − O) mod 2²⁴) |

In this exemplary embodiment, this token category contains four token types. The first token type “Verbatim” having the main symbol S=2 has just a single type of token that exactly describes an already decompressed word 30. The type of token in this respect contains the main symbol S and, as second portion, an offset 34 that indicates how many words 30 are before the word 30 that is repeated. Extra bits are not present in tokens 28 from the category of single-word repetitions. The second token type “1-Bit Delta” in each case indicates a word 30 that deviates from a previously decompressed word 30 by just one bit. There are 32 possibilities for where this bit may be situated. This token type accordingly has 32 different types of token that are referenced by one of the main symbols 3-34. In this respect, the main symbol S unambiguously indicates where the one-bit difference lies in the word 30.

In the same way, the token type “2-Bit Delta” stands for a word that differs from a previously unzipped word 30 by two bits behind another, that is to say immediately adjacent bits. Since there are 31 positions where this bit pair may be, this token type has 31 types of token.

The fourth token type “ARM branch” converts a relative jump command in an uncompressed word 30 into an absolute address. In a program, there are often jumps from various points to a specific point in the program. The corresponding jump commands are contained in the uncompressed program data in the form of relative jumps. By virtue of the conversion into the absolute address within the program data 24, these jump commands are all the same and thereby able to be compressed to a greater extent.

In summary, tokens 28 of the types of token from the category of single-word repetitions describe a single word that is already present beforehand in the uncompressed data block. These tokens 28 consist of the main symbol and the relative offset. Such tokens 28 may optionally contain information about where a bit or two bits behind one another differ between the already decompressed word and the word to be decompressed. The main symbol in this case carries information about how the already decompressed word should be changed in order to reproduce the word that is currently to be decompressed. In the event of a change, this change consists of the inversion of one or two bits in the reference word that is to be copied and has already been decompressed, or alternatively in an address transformation of a jump command.

A table of the token types from the category of multi-word repetitions is depicted below.

TABLE 3
Tokens from the category of multi-word repetitions

| | Main | Number of | |
|---|---|---|---|
| | symbol | extra bits | |
| Token type | (S) | (B) | Word number |
| Inline | 216-279 | 0 | S-216 + 2 |
| External | 280 | 32 | B |

These token types consist of the main symbol and an offset and possibly one or more extra bits. The main symbol depicts the number of words 30 that are to be repeated true to character and exactly in this order. The offset indicates where this series of words 30 to be repeated are situated in relation to the word 30 to be decompressed, which expands into this plurality of words 30 in the decompressed form.

In the case of the token type “Inline”, the main symbol S describes the number of words 30 that should be repeated. The smallest main symbol of the token type, in this case 216, in this respect describes two words 30 that are repeated. The higher the main symbol, the more words 30 is repeated. The token type “External” contains just a single type of token that contains, in addition to the main symbol, in this case 280, the offset and a number of extra bits, at most 32 extra bits. These extra bits indicate how many words 30 should be repeated. In this way, it is also possible to reproduce an extremely long string for example of several 1000 words 30 to be repeated in a single token 28.

The types of token from the category of multi-word repetitions in this respect describe a sequence of two or more repeated words 30 that are present in an offset in the already decompressed data block. This series of words 30 is repeated true to character without changes.

A table of the token types from the category of strings of identical words is depicted in the following table.

TABLE 4
Tokens from the category of strings of identical words

| | Main | Number of | |
|---|---|---|---|
| | symbol | extra bits | Length of the |
| Token type | (S) | (B) | word string |
| Inline | 151-214 | 0 | S-151 + 1 |
| External | 215 | 32 | B |

These token types indicate that an immediately preceding decompressed word is repeated and how often it is repeated. Types of token from the category of strings of identical words thus describe a sequence of an individual word that is repeated once or several times. The repeated word is always immediately directly after the last decompressed word. The source word that is repeated thus has the relative offset 1.

The token type “Inline” in this case already indicates, by way of its main symbol S, how often the word should be repeated. The main symbol 151 indicates for example that the last word is repeated once. In the case of the main symbol 152, the word is repeated twice, and so on. Since the main symbol S already indicates how often the word should be repeated, no extra bit is necessary. Extra bits only become necessary when the number of repetitions of the previous word exceeds the number of available main symbols S. In this case, the main symbol 215 is used and a number of extra bits, at most 32 bits, which indicate how often the word should be repeated.

As in the case of multi-word repetitions as well, the type of token coding, which takes place through the main symbol S, in the case of a string of identical words already indicates how often a single word should be repeated, or in the case of multi-word repetitions, how many possibly different words should be repeated behind one another. In the case of a relatively large number of word repetitions, the extra bit coding is used, to which the corresponding main symbol then makes reference.

The tokens 28 from the intermediate level 26 are compressed in the second compression step using the Huffman compression. To this end, a plurality of Huffman trees is generated that are specified in uncompressed form at the beginning of the compressed data block. Three Huffman trees are used in this exemplary embodiment. The main symbol S of the tokens 28 is coded or compressed using a main tree. Two Huffman trees are available to compress the offset 32. The offsets of the single-word repetitions are coded using a Huffman tree, indicated in FIG. 3 as “Short Tree”. The offsets of the multi-word repetitions are coded using another Huffman tree, which is referenced “Long Tree” in FIG. 3.

Which of the Huffman trees is to be used, for both compression and decompression, results from the previously decompressed main symbol S, by way of which the category of the token 28 to be decompressed is defined. The main symbol also defines whether or not extra bits 34 are present. The number of extra bits 34 is also already unambiguously depicted by the main symbol. As a result, the overall length of the token 28 is known, and so tokens 28 arranged immediately behind one another are also able to be separated unambiguously from one another.

A table of all of the token types, broken down according to the main symbol S, is depicted below.

TABLE 5
Main alphabet

| Main | | | | Number of |
|---|---|---|---|---|
| symbol | Token | | | extra bits |
| (S) | category | Token type | Offset | (B) |
| 0 | True to | Zero | 0 | 0 |
| 1 | character | Verbatim | 0 | 32 |
| 2 | Single-word | Verbatim | + | 0 |
| 3-34 | | 1-Bit Delta | + | 0 |
| 35-65 | | 2-Bit Delta | + | 0 |
| 66 | | | + | 0 |
| 67-87 | True to | Short | 0 | S-67 |
| 88-108 | character | Sparse | 0 | S-88 |
| 109-129 | | Short Negative | 0 | S-109 |
| 130-150 | | Sparse Negative | 0 | S-130 |
| 151-214 | String | Inline | 0 | 0 |
| 215 | | External | 0 | 32 |
| 216-279 | Multi-word | Inline | + | 0 |
| 280 | | External | + | 32 |

It is able to be seen that each token 28 has a main symbol S that is compressed by the main tree of the Huffman coding. The fourth column depicts the presence of offset bits, which are shown by a “+” in the table. It is able to be seen that only tokens 28 of the token types of the single-word and multi-word repetitions each have an offset 32. Of these, only the token type having the main symbol 280 also has extra bits 34 in addition to the offset. All of the other tokens 28 have just one or two symbols, namely the main symbol S and, in the case of a second symbol, either offset 32 or extra bit 34. To compress a token 28 of the type having the main symbol 0, only the main symbol S needs to be compressed, for example. The same applies to the tokens 28 of the type having the main symbol 151-214.

The maximum length of the symbols coded by a Huffman tree is limited to 12 bits for the main tree and to 10 bits for the two offset trees. Although this restriction leads to a slightly suboptimal code assignment in the case of the Huffman compression, this restriction makes it possible to decode all of the Huffman codes with the use of three individual lookup tables, which require only 12 kilobytes of memory space and normally fit into the L1 cache of the CPU 12 executing the decompression algorithm.

The main symbol S compressed by the main tree of the Huffman compression is always the first portion of any token 28 in the compressed form of the token 28. This symbol S unambiguously defines the next steps of the decompression of the entire token 28.

The size of the offsets 32 is at least 1 in the case of single-word repetitions and at least 2 in the case of multi-word repetitions. The largest offset 32 in the case of single-word repetitions is 4096. That is to say that single-word repetitions are normally able to be executed with the data stock from the L1 cache, provided that this contains the last 4096 words. The decompression is thereby very fast. The offset model is depicted in the following table.

TABLE 6
Offset alphabet

| | | | Number of | |
|---|---|---|---|---|
| Offset | | Offset | extra bits | Offset (m = |
| symbol (S) | Category | Encoding | (B) | Minimal offset) |
| 0-31 | Single-word | Direct | 0 | S + m |
| 32-39 | and multi- | Dictionary | 0 | D(S-32) |
| 40-151 | word | Grouped | n = G + 1 | (3) |
| 152-199 | Multi-word | Grouped | n = G + 1 | (3) |
| 200 | | Verbatim | 32 | B |

It is able to be seen from the table that the offset 32 is indicated directly only in some cases, as is able to be seen in the first row. An offset 32 of 1 to 32 words carries the offset symbol 0 to 31 and is indicated directly. Such an indication of larger offsets 32 would be highly memory-intensive. In this respect, a new offset group has been created that bears the name “Dictionary” in this exemplary embodiment. This offset group consists of a series of previously defined offsets 32 that are not behind one another. Offsets 32 that occur often and are thereby easily able to be coded are expediently selected. From such offsets 32, which are applied more often than average in the compression, a predetermined number of offsets 32, for example 8 offsets, are selected and each given a fixed offset symbol. Such offsets 32 may be reproduced in what is known as an offset dictionary.

In the case of grouped offsets 32, the offset symbol only indicates a group of offsets 32, that is to say an offset range. The exact offset 32 may be defined by extra bits, as indicated for example in the table of the offset alphabet, G being able to be described by the following formula:

$$G = ⌊ \frac{S - 40}{{2}^{4}} ⌋ .$$

The offset 32 in this case results from the following equation:

0=(2^{G}−1)×2⁵+2ⁿ×((S−40)mod 2⁴)+B+32+m.

Some particularly large offsets 32 may be given a specific offset symbol, in this case 200, and be indicated precisely by 32 extra bits. An offset 32 up to 4 gigabytes is thereby able to be described.

The compressed data block consisting of compressed program data 22, at its beginning, carries a header consisting of for example 7 words each having 32 bits. The following table describes the fields or individual words of the header.

TABLE 7
Compressed header

| Word | Content | Description |
|---|---|---|
| 0 | 0x2EB9A007 | Signature/Byte order mark |
| 1 | 4 | Algorithm identifier |
| 2 | Variable | Uncompressed word count |
| 3 | | Compressed model word count following header |
| 4 | | Compressed data word count following model |
| 5 | | Uncompressed data checksum |
| 6 | | Header checksum |

The data indicated in the header are intended to render detectable a data corruption resulting from an incorrect transmission, compression or decompression. Errors are thereby able to be detected quickly and reliably, and a corresponding error notification is able to be output. Following the header is a sequence of words that reproduce the three Huffman trees and also the entries of the offset dictionaries that contain offsets of single-word and multi-word repetitions, which offsets occur frequently for the decompression. This model data sequence consists of a series of bit sequences of predefined length, which are divided into 32-bit words. Each bit sequence constitutes a machine integer, the most significant bit coming first. The bit series 1101 in this respect represents the value 13. Bit sequences are zipped in words in the order from the highest-value to the lowest-value bit, wherein they are able to exceed a word limit. The last word—if necessary—is filled with zeros. The model series is defined as follows:
1. Offset dictionary of single-word repetitions
2. Offset dictionary of multi-word repetitions
3. Huffman main tree
4. Huffman offset tree for single-word repetitions
5. Huffman offset tree for multi-word repetitions

The data lengths of the three Huffman trees are combined into a single sequence that consists of 634 data lengths between 0 and 12, or 10 for the offset trees. A data length of 0 means that the corresponding symbol is not used and is therefore not in the Huffman tree.

As is able to be seen from FIG. 3, the compressed program data 22 are arranged in two interlinked sequences. The first sequence contains the symbols compressed by the Huffman trees and those extra bits that have not gone through a Huffman compression, whose length is less than 32 bits. The correspondingly coded data are arranged behind one another and grouped into 32-bit words, as illustrated in FIG. 3. The second sequence contains entire 32-bit words 36. If for example, in a true to character reproduction, an entire word 36 consisting of 32 bits is not coded either by the LZ compression or by the Huffman compression, then this word 36 fills a word 36 of the second sequence. Such an interlinked arrangement of words 36 of both sequences minimizes the number of memory access operations within the decompression method.

An uncompressed 32-bit word 36 of the second sequence follows such a word 36 of the first sequence, into which the uncompressed word 30 of the second sequence would be incorporated if the data order of the uncompressed program data 24 were to be considered. However, this word 36 of the second sequence is not inserted into the corresponding word 36 of the first sequence, but rather only attached to the end thereof. If two uncompressed words 36 are situated behind one another, then these two words 36 are attached in the form of intermediate words behind the corresponding word 36 of the first sequence.

The complete data block consisting of compressed program data 22 may additionally be divided into a plurality of sub-blocks. In this case, the number of such data blocks expediently matches that of the computer cores of the CPU 12. In this way, two or more compressed data blocks are able to be decompressed in parallel by the same number of computer cores of the CPU. This has the advantage that whenever the L2 cache of the embedded system requests a new cache row from the non-volatile memory 14, another CPU core is able to continue with the decompression of the data that are already in the L2 cache. The decompression of the data blocks therefore overlaps, which may lead to a reduction of loading and decompression time almost as far as the pure transfer time of the program data 22 from the non-volatile memory 14 to the CPU 12.

In order to design this parallel decompression efficiently, it is expedient to divide the data block of the uncompressed program data 24 into parts or data blocks that are at least approximately the same size in the compressed state, for example have a size difference of at most 10%. The data size of the plurality of blocks in uncompressed form may of course be very different. The number of tokens 28 in the intermediate level 26 may provide an indication. By way of example, the plurality of data blocks have the same or a similar number of tokens 28, the number of tokens 28 being at most 10% different between the plurality of data blocks.

To decompress the program data 22, the words 36 of the compressed program data 22 are transferred consecutively from the non-volatile memory 14 into the CPU 12. The individual words 36 are decompressed there into the intermediate level 26 in accordance with the unambiguous Huffman coding with the additional assistance of the Huffman trees, such that the compressed words 36 are converted into a sequence of tokens 28. This sequence is then decompressed in succession, token for token, in accordance with the LZ compression method used for the compression. The uncompressed words 30 are generated in accordance with the order of the tokens 28 and form the program data 24. These are able to be used for example to configure the FPGA 20.

This decompression, in the first step of the Huffman decompression, involves a single-step decompression of the Huffman tree symbols using lookup tables. One efficient way for constructing such lookup tables is their format in three fields of 4096 or 1024 16-bit values, depending on the Huffman tree that is used.

Decoding or decompression of the tokens 28 is also efficient, since all of the information of a token 28 is limited to at most 32-bit variable length and up to two further 32-bit true to character words 30. In this respect, the data of a single buffer memory fill is sufficient to decompress the entire token 28.

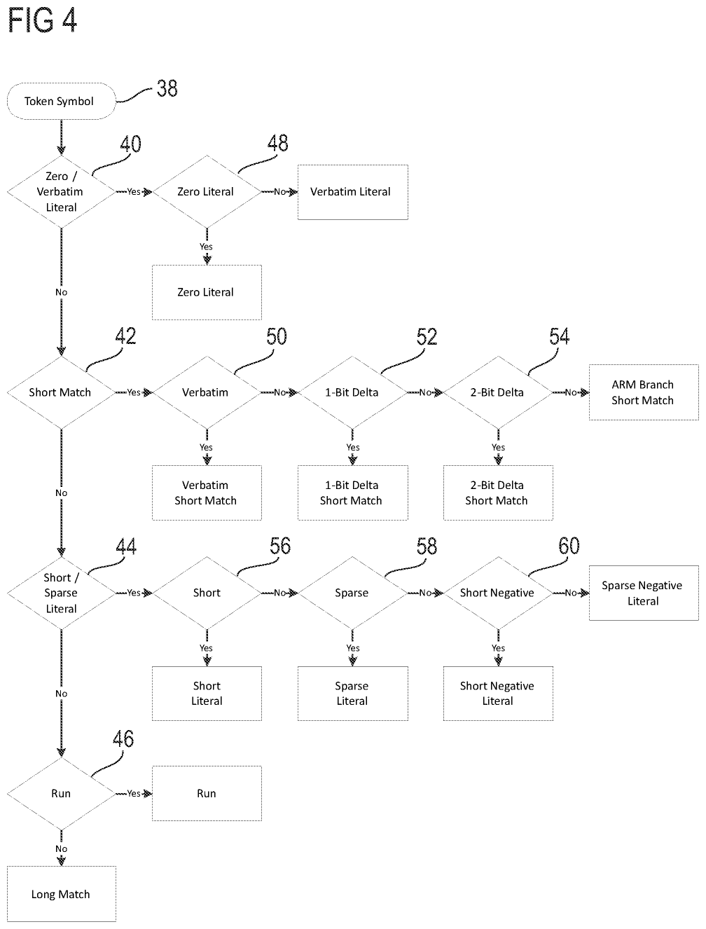

In the case of the decompression of a token 28, the main symbol S is decompressed first of all in order to determine the type of token. Depending on the type of token 28, this may lead to a relatively high number of branches and thus be comparatively time-intensive. It is therefore advantageous to arrange the decompression decisions such that their order matches the probability of occurrence of the various types of token. FIG. 4 shows a suitable order of such branching.

FIG. 4 shows a flowchart of a method for decompressing tokens 28. The token symbol or main symbol S is first of all read in step 38. In steps 40 to 46, the type of token is then queried, beginning with types of token that occur most frequently among the tokens 28. The order also corresponds to the main alphabet from the above Table 5. Token types from the category of true to character reproduction are first of all queried. Then token types from single-word repetitions, then the remaining token types from the category of true to character reproduction, and finally the token types from the strings of identical words. The last token types from the multi-word repetitions result as the remainder of all of the token types. If a positive query in the branches 40 to 46 finds the token category or class of the token types, then the exact token type is determined in further queries 48 to 60. Due to this query order, it is possible to determine the token type in a time-efficient manner.

The following is a summary list of reference numerals and the corresponding structure used in the above description of the invention:
2 Air defense system
4 Missile
6 Canister
8 Vehicle
10 Data processing system
12 CPU
14 Non-volatile memory
16 Volatile memory
18 Software
20 FPGA
22 Program data
24 Program data
26 Intermediate level
28 Token
30 Word
32 Offset
34 Extra bit
36 Word
38 Read token symbol
40-60 Branch

1. A method for booting a data processing system, which comprises the steps of:
transferring a boot loader from a non-volatile data memory to a central processing unit (CPU), the boot loader boots the data processing system and prompts a situation whereby compressed program data from the non-volatile data memory are decompressed by the CPU and are stored in decompressed form in a volatile data memory, and are called therefrom at a program startup, and are used to execute a program.

2. The method according to claim 1, wherein the compressed program data are field-programmable gate array (FPGA) firmware by way of which an FPGA is configured.

3. The method according to claim 1, wherein the compressed program data are present exclusively in a form of words of multi-byte size of a same size, both in compressed form in the non-volatile data memory and in decompressed form in the volatile data memory.

4. The method according to claim 1, which further comprises compressing the compressed program data by way of a first compression method from a Lempel-Ziv (LZ) family and subsequent Huffman compression and are decompressed using such corresponding methods.

5. The method according to claim 1, which further comprises entropy encoding the compressed program data and all of the compressed program data used to start up the data processing system are decompressed by way of at most three Huffman trees.

6. The method according to claim 5, which further comprises:
using one of the Huffman trees to determine a type of token; and
using at least one further one of the Huffman trees to determine backwards offset to data of a same type.

7. The method according to claim 1, wherein the decompression uses at most three single-stage lookup tables that each contain a field of at most 4096 16-bit values.

8. The method according to claim 1, wherein the compressed program data form a complete program dataset that is routed exclusively through L1 cache of the CPU for the decompression, wherein access operations to already decompressed data take place at least predominantly on L2 cache of the CPU in order to further decompress the compressed program data.

9. The method according to claim 1, which further comprises using tokens for the decompression, the tokens contain, as data content, a symbol for a type of token at a front and optionally a symbol for an offset and/or a maximum of 32 extra bits behind this.

10. The method according to claim 9, wherein a number of the extra bits is defined by the type of token.

11. The method according to claim 9, wherein a token category from a true to character reproduction containing the tokens is used for the decompression, the token category compresses a series of characters consisting of zeros or ones placed at a front or placed at a rear separately from a true to character portion.

12. The method according to claim 9, which further comprises using a token category of single-word repetitions for the decompression whose tokens each refer to an earlier word and permit changes of one or two bits situated behind one another.

13. The method according to claim 9, which further comprises using a token category of multi-word repetitions for the decompression whose tokens each denote a plurality of identical words situated immediately behind one another.

14. The method according to claim 9, which further comprises using a token category of strings of identical words for the decompression whose tokens each refer to a series of identical words situated immediately in front of one another.

15. The method according to claim 9, wherein for the decompression of different token types, an order of the token types is checked such that the token types of a true to character token category are checked first of all, and then the token types of a token category of single-word repetitions are checked and then further token types of the true to character token category are checked.

16. The method according to claim 1, wherein the compressed program data form a complete program dataset that is compressed as a single data block, whose model portion contains all decoding trees that are used for the decompression.

17. The method according to claim 1, wherein the compressed program data are present in two interlinked sequences each consisting of words of a same length, wherein a first word sequence consists of the compressed program data and a second word sequence consists of uncompressed program data.

18. The method according to claim 1, wherein the compressed program data are present in a plurality of data blocks, wherein a number of the data blocks matches a number of computer cores of the CPU.

19. The method according to claim 18, wherein a number of tokens in the data blocks differ from one another by at most 20%.

20. An air defense system, comprising:
a missile; and
a data processing system for controlling operation of said missile, said data processing system having a central processing unit (CPU), a volatile memory and a non-volatile memory and containing software which, when the software is executed, has the effect that compressed program data from said non-volatile data memory are decompressed by said CPU and are stored in decompressed form in said volatile data memory, and are called therefrom at a program startup and are used to execute a program.
